(19) United States
(12) Patent Application Publication
(10) Pub. No.: US 2025/0200587 A1
(43) Pub. Date: Jun. 19, 2025

(54) DISPUTE CONTESTATION AUTOMATION

(71) Applicant: PayPal, Inc., San Jose, CA (US)

(72) Inventors: Saili Deshpande, San Jose, CA (US); Arpit Kumar, Vancouver (CA); Deepak Jagadeesh, San Jose, CA (US); Ananth Gopal, Fremont, CA (US); Ravidutta Ramesh Kodre, San Jose, CA (US); Zijie Poh, San Francisco, CA (US); Muhammad Ahmed Tajammul Chaudhry, San Jose, CA (US)

(21) Appl. No.: 18/543,833

(22) Filed: Dec. 18, 2023

(51) Int. Cl. G06Q 30/016; G06N 20/00

(52) U.S. Cl. CPC G06Q 30/016; G06N 20/00

(57) ABSTRACT

Systems, methods, and computer program products for using machine learning to determine whether to dispute a chargeback request are provided. A dispute processing system receives a chargeback request for a transaction, transaction data and service provider data associated with the transaction. The dispute processing system incorporates the transaction and service provider data into a template. Next, the dispute processing system uses a machine learning framework to generate machine learning scores that indicates a likelihood of successfully winning the chargeback request and avoiding pre-arbitration. Using the machine learning scores, the transaction data, the service provider data, and at least one dispute processing rule, the dispute processing system determines a likelihood of successfully challenging the chargeback request. Based on the likelihood of successfully contesting the chargeback request, the dispute processing system generates a contestation document from the template, and submits the contestation document to contest the chargeback request.

### TECHNICAL FIELD

The disclosure generally relates to automatically contesting electronically generated disputes, and more specifically to using machine learning to automatically predict an outcome of a dispute at various stages and use the prediction to optimize the recovery.

### BACKGROUND

When a customer files a chargeback request with a credit card issuer, the chargeback request indicates that a customer is disputing a charge and requesting a refund. A chargeback request may result in a merchant losing the goods or services provided and the corresponding amount paid for the goods or services. To recover the disputed amount, a merchant may contest the chargeback request. Disputing a contested amount may significantly impact the merchant's revenue due to a chargeback fee in addition to the amount paid for the goods or services. The embodiments are directed to training and building a machine learning framework that is trained to automatically identify a likelihood of success of a merchant disputing the chargeback request.

### BRIEF DESCRIPTION OF THE DRAWINGS

FIG. 1 is an exemplary system where an automated dispute processing system can be implemented.

FIG. 2 is a block diagram of an automated disputed processing system, according to some embodiments.

FIGS. 3A-F are diagrams of a dispute processing system interface, according to some embodiments.

FIGS. 4A-B area block diagrams of machine learning models implemented as a neural network, according to some embodiments.

FIG. 5A-B are block diagrams of machine learning models implemented as an ensemble of trees, according to some embodiments.

FIG. 6 is a flowchart of a method for automatically determining whether to contest a chargeback request, according to an embodiment.

FIG. 7 is a block diagram of a computer system suitable for implementing one or more components or operations in FIGS. 1-6 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Embodiments are directed to an automated dispute processing system that determines a contestation decision. The contestation decision indicates whether to contest a chargeback request and generates a contestation document for contesting the chargeback request. Specifically, when the dispute processing system receives a chargeback request, the dispute processing system collects transaction data and service provider/merchant data associated with a transaction subject to the request. Next, the dispute processing system analyzes the transaction data and service provider/merchant data using one or more trained machine learning models to determine a likelihood of successfully winning the chargeback request and avoiding a pre-arbitration. Using data generated by the merchant and user, the automated dispute processing system may generate a score indicating a likelihood of winning the chargeback and avoiding arbitration or pre-arbitration. Based on the score, the automated dispute processing system may determine whether or not to contest the chargeback request. If the automated dispute processing system determines to contest the chargeback request, the dispute processing system may generate a contestation document that includes transaction data and service provider/merchant data and automatically submit the contestation document to dispute the chargeback request.

The dispute processing system may also include a dispute processing system interface. The dispute processing system interface may display a list of disputes subject to chargeback requests and individual disputes corresponding to the chargeback request, along with the status of the chargeback request. As the dispute processing system receives transaction data and service provider/merchant data from multiple devices in a computing environment and automatically determines whether to dispute the chargeback request, the dispute processing system interface automatically updates the status of the chargeback request on a display of a computing device.

There are multiple benefits to an automatic dispute processing system. First it automatically identifies a likelihood of succeeding in disputing chargeback requests with and without a pre-arbitration process thus accelerating response time to the chargeback requests and increasing the chargeback success rate. Second, the automatic dispute processing system may reduce the contestation rate and overall chargeback related fees to the merchant. Third, a machine learning framework in the dispute processing system is optimized to process the transaction data and service provider/merchant data to determine multiple scores associating the likelihood of successfully disputing the chargeback requests at various stages (e.g., without pre-arbitration process, and during the pre-arbitration process). For example, the machine learning framework is optimized using a predefined number of historical transactions that occur over a predefined time period and are updated in real-time, making the machine learning framework more accurate in determining the likelihood of winning at different stages. Further, since the chargeback requests are time sensitive, the machine learning framework is optimized to efficiently determine one or more scores on-demand for time sensitive requests or in aggregate for not time sensitive requests. Third, the dispute processing system automatically updates a user interface with a status of chargeback requests thus providing real-time status updates of multiple chargeback requests associated with a service provider. Finally, dispute processing system may be re-trained on current and up to date data at predefined time intervals or in real-time which improves accuracy of the dispute processing system and maximizes the recovery rate for the merchant or service provider.

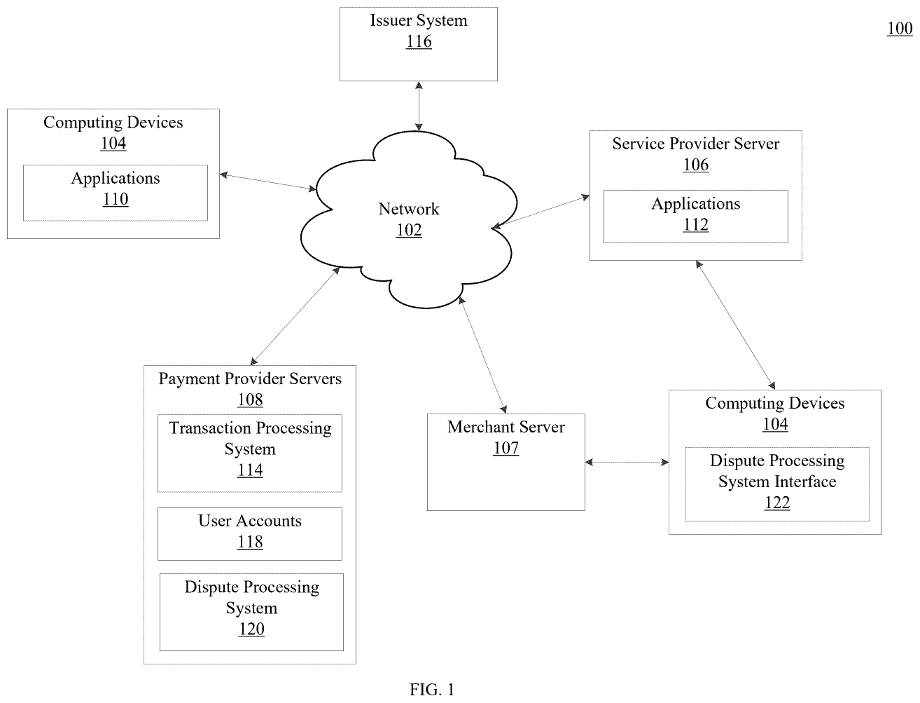

FIG. 1 is an exemplary system 100 where embodiments can be implemented. System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104, service provider server(s) 106, merchant server(s) 107, and payment provider server(s) 108. Computing devices 104 may be portable and non-portable electronic devices under the control of a user and configured to transmit, receive, and manipulate data from service provider server(s) 106 and payment provider server(s) 108 over network 102. Example computing devices 104 include desktop computers, laptop computers, tablets, smartphones, wearable computing devices, eyeglasses that incorporate computing devices, implantable computing devices, etc.

Computing devices 104 may include one or more applications 110. Applications 110 may be pre-installed on the computing devices 104, installed on the computing devices 104 using portable memory storage devices, such as compact disks or thumb-drives, or be downloaded to the computing devices 104 from service provider server(s) 106 and/or payment provider server(s) 108. Applications 110 may execute on computing devices 104 and receive instructions and data from a user, from service provider server(s) 106, merchant server(s) 107, and payment provider server(s) 108.

Example applications 110 may be payment transaction applications. Payment transaction applications may be configured to transfer money world-wide, receive payments for goods and services, manage money spending, etc. Further, applications 110 may be under an ownership or control of a payment service provider, such as PAYPAL® Inc. of San Jose, CA, USA, a telephonic service provider, a social networking service provider, and/or other service providers. Applications 110 may also be analytics applications. Analytics applications perform business logic, provide services, and measure and improve performance of services and functions of other applications that execute on computing devices 104 based on current and historical data. Applications 110 may also be security applications for implementing client-side security features, programmatic client applications for interfacing with appropriate application programming interfaces (APIs) over network 102, communication applications, such as email, texting, voice, and instant messaging applications that allow a user to send and receive emails, calls, texts, and other notifications through network 102, and the like. Applications 110 may be location detection applications, such as a mapping, compass, and/or global positioning system (GPS) applications, social networking applications and/or merchant applications. Additionally, applications 110 may be service applications that permit a user of computing device 104 to receive, request and/or view information for products and/or services, and also permit the user to purchase the selected products and/or services.

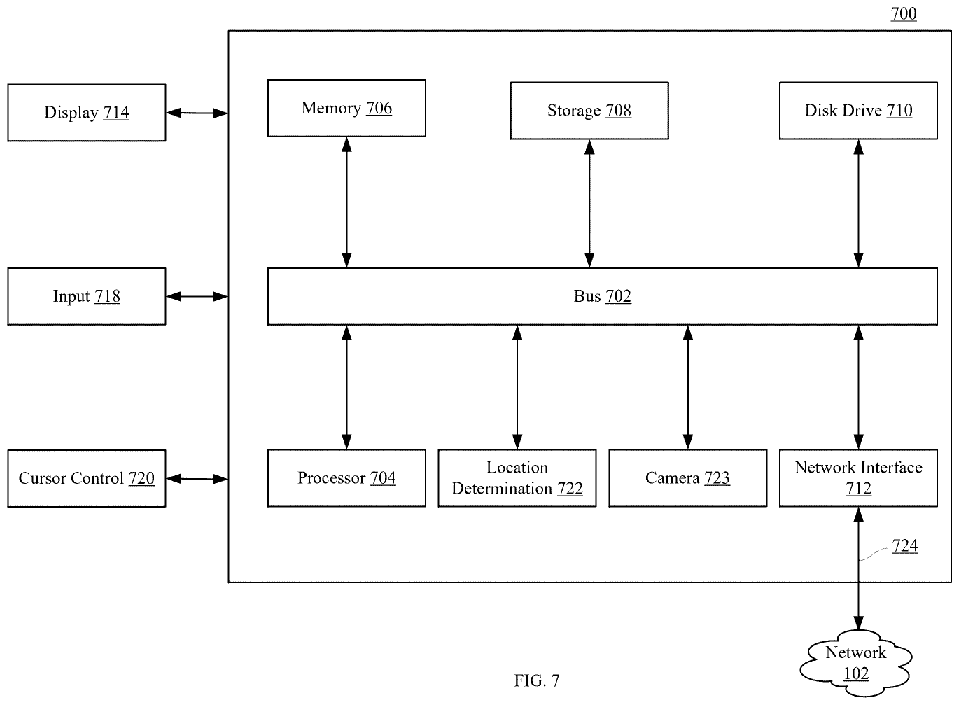

In an embodiment, applications 110 may utilize numerous components included in computing device 104 to receive input, store and display data, and communicate with network 102. Example components are discussed in detail in FIG. 7.

As discussed above, one or more service provider servers 106 may be connected to network 102. Service provider server 106 may also be maintained by a service provider, such as PAYPAL®, a telephonic service provider, social networking service, and/or other service providers. Service provider server 106 may be software that executes on a computing device configured for large scale processing and that provides functionality to other computer programs, such as applications 110 and applications 112 discussed below.

In an embodiment, service provider server 106 may initiate and direct execution of applications 112. Applications 112 may be counterparts to applications 110 executing on computing devices 104 and may process transactions at the requests of applications 110. For example, applications 112 may be financial services applications configured to transfer money world-wide, receive payments for goods and services, manage money spending, etc., that receive message from the financial services applications executing on computing device 104. Applications 112 may be security applications configured to implement client-side security features or programmatic client applications for interfacing with appropriate application programming interfaces (APIs) over network 102. Applications 112 may be communication applications that perform email, texting, voice, and instant messaging functions that allow a user to send and receive emails, calls, texts, and other notifications over network 102. In yet another embodiment, applications 112 may be location detection applications, such as a mapping, compass, and/or GPS applications. In yet another embodiment, applications 112 may also be incorporated into social networking applications and/or merchant applications.

In an embodiment, applications 110 and applications 112 may process transactions on behalf of a user. In some embodiments, to process transactions, applications 110, 112 may request payments for processing the transactions via payment provider server(s) 108. For instance, payment provider server 108 may be a software application that is configured to receive requests from applications 110, 112 that cause the payment provider server 108 to transfer funds of a user using application 110 to service provider associated with application 112. Thus, applications 110 and 112 may receive user data, including user authentication data, for processing any number of electronic transactions, such as through payment provider server 108.

Merchant servers(s) 107 may be connected to network 102. Merchant server 107 may be maintained by a merchant such as an entity that may be involved in trade of goods. Merchant server 107 may be software that executes on a computing device configured for large and small scale processing and that provides functionality to other computer programs to purchase goods at various locations, e.g., at stores around the world, or online through application 110.

In an embodiment, payment provider servers 108 may be maintained by a payment provider, such as PAYPAL®. Other payment provider servers 108 may be maintained by or include a merchant, financial services provider, credit card provider, bank, and/or other payment provider, which may provide user account services and/or payment services to a user. Although payment provider servers 108 are described as separate from service provider server 106, it is understood that one or more of payment provider servers 108 may include services offered by service provider server 106 and vice versa.

Each payment provider server 108 may include a transaction processing system 114. Transaction processing system 114 may correspond to processes, procedures, and/or applications executable by a hardware processor. In an embodiment, transaction processing system 114 may be configured to receive information from one or more applications 110 executing on computing devices 104 and/or applications 112 executing on service provider server 106 for processing and completion of financial transactions. Financial transactions may include financial information corresponding to user debit/credit card information, checking account information, a user account (e.g., payment account with a payment provider server 108), or other payment information. Transaction processing system 114 may complete the financial transaction for the purchase request by providing payment to application 112 executing on service provider server 106. For example, transaction processing system 114 may communicate with one or more issuer systems 116, such as credit card, debit card, and/or bank systems, to provide payment for the transaction to application 112 executing on service provider server 106.

Payment provider server 108 may also include user accounts 118. Each user account 118 may be established by one or more users using applications 110 with payment provider server 108 to facilitate payment for goods and/or services offered by applications 112. User accounts 118 may include user information, such as name, address, birthdate, payment/funding information, travel information, additional user financial information, and/or other desired user data. In a further embodiment, user accounts 118 may be stored in a database or another memory storage described in detail in FIG. 7.

A user may use computing device 104 to file a chargeback request or charge dispute with issuer system 116. A chargeback request indicates that a user is disputing a charge made by service provider server 106 and is requesting a refund. A chargeback request may be initiated due to various reasons, such as a transaction being perceived as fraudulent, an incorrect or duplicate amount charged, a chargeback for an item that has not arrived or was returned, and the like. In response, the issuer system 116 may temporarily refund the funds to the user using computing device 104 from service provider server 106. The service provider server 106 may then contest the chargeback request and prove that the transaction is legitimate. If the chargeback request is not contested or the service provider server 106 is unable to prove that the transaction is legitimate, the temporary refund of funds becomes permanent.

Payment provider server 108 may include an automated dispute processing system 120. Dispute processing system 120 may determine whether service provider server 106 should or should not contest the charge back request. Automation is particularly useful to service providers that receive thousands of chargeback requests and manually evaluate whether to contest the chargeback request with the issuer system 116. Not only a manual process is time consuming, the issuer system 116 also charges service providers a chargeback fee for each disputed transactions, resulting in revenue loss due to numerous chargeback fees. By determining whether to dispute or not dispute a chargeback request, the dispute processing system 120 may maximize the service provider's revenue by contesting chargeback requests that are predicted to be successful and not contesting the chargeback request that are predicted to be unsuccessful. The automated dispute processing system 120 thus saves processing time and reduces chargeback fees by contesting a subset of all chargeback requests that it determined to likely be successful.

To determine whether or not to contest a chargeback request, dispute processing system 120 may collect data. The data may be associated with a transaction subject to a chargeback request, historical data associated with the user account 118 of a user requesting a charge back, and historical data associated with the service provider server 106. Using the data, dispute processing system 120 may use a machine learning framework that includes one or more machine learning models to determine a likelihood of service provider server 106 succeeding in contesting the chargeback request.

Dispute processing system 120 may collect data associated with a transaction using a dispute processing system interface 122. Dispute processing system interface 122 may execute on computing device 104 that is communicatively connected to service provider server 106 and/or merchant server 107 over network 102 or over another network. Dispute processing system interface 122 may receive input that includes the data from service provider server 106. Additionally, dispute processing system interface 122 may include an interactive user interface that may display existing chargeback requests and may be traversed to display information associated with one of the chargeback requests. Additionally, dispute processing system interface 122 may receive information, including data, documents, etc., that may be used to determine whether to contest the chargeback request, display the status of each chargeback request, the likelihood of succeeding in contesting the chargeback request, and the like.

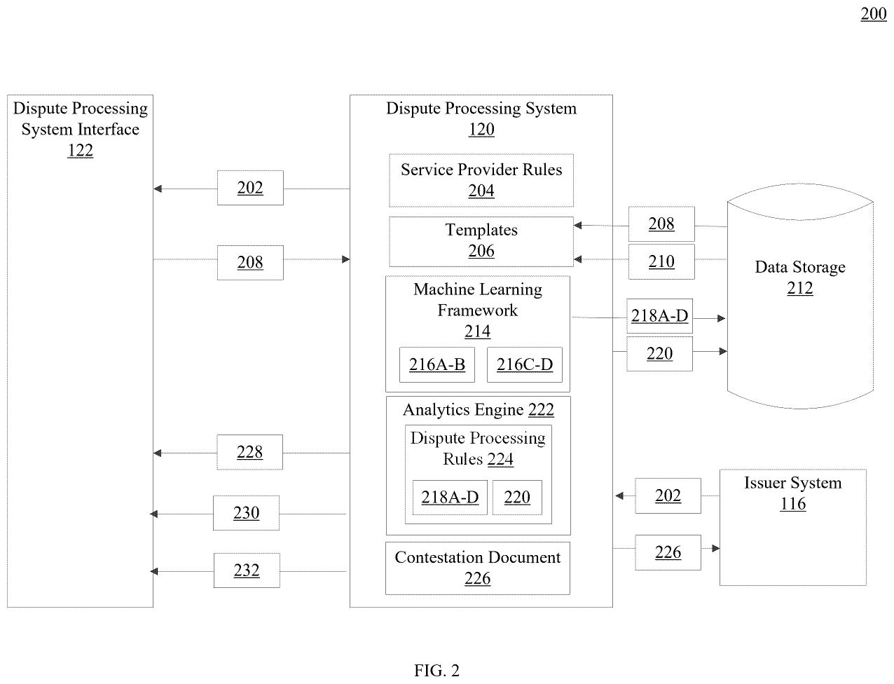

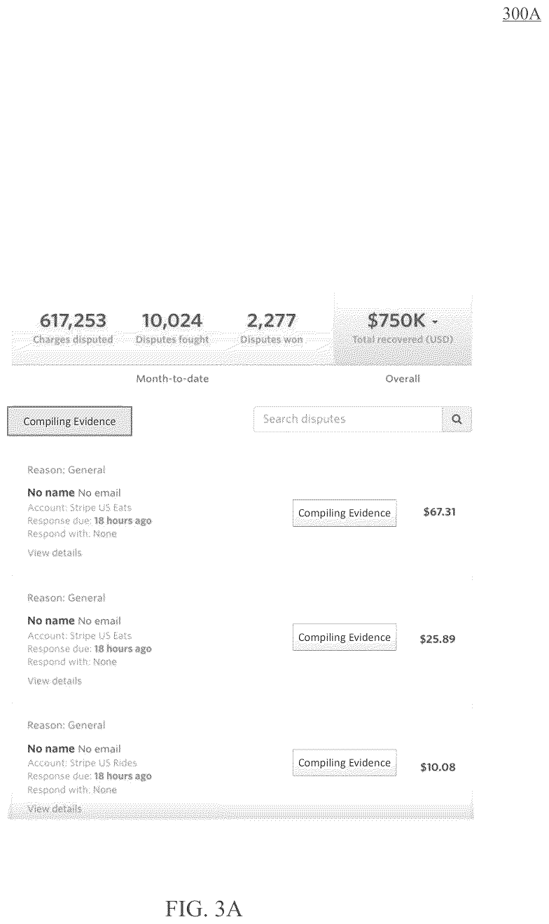

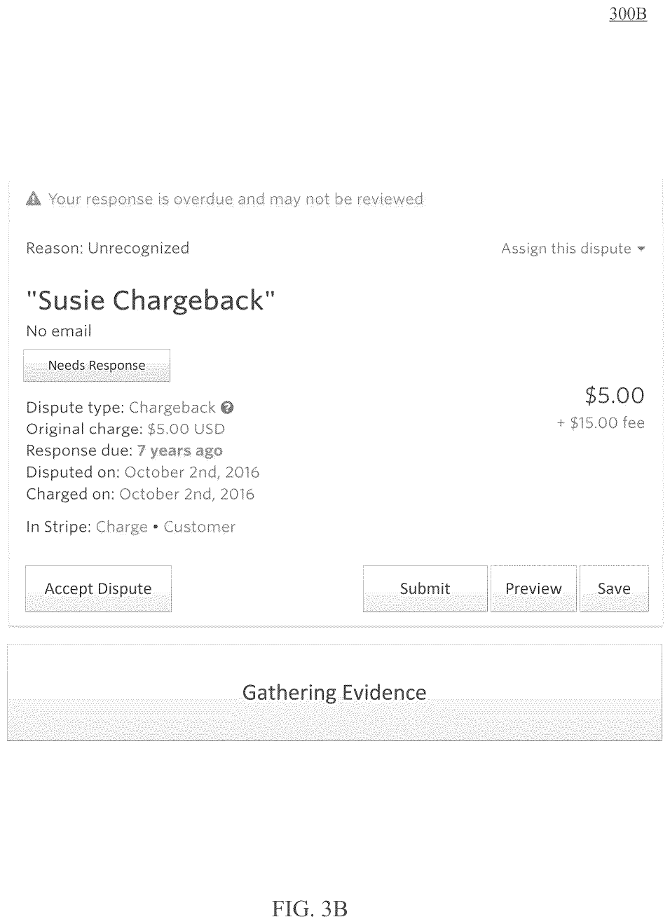

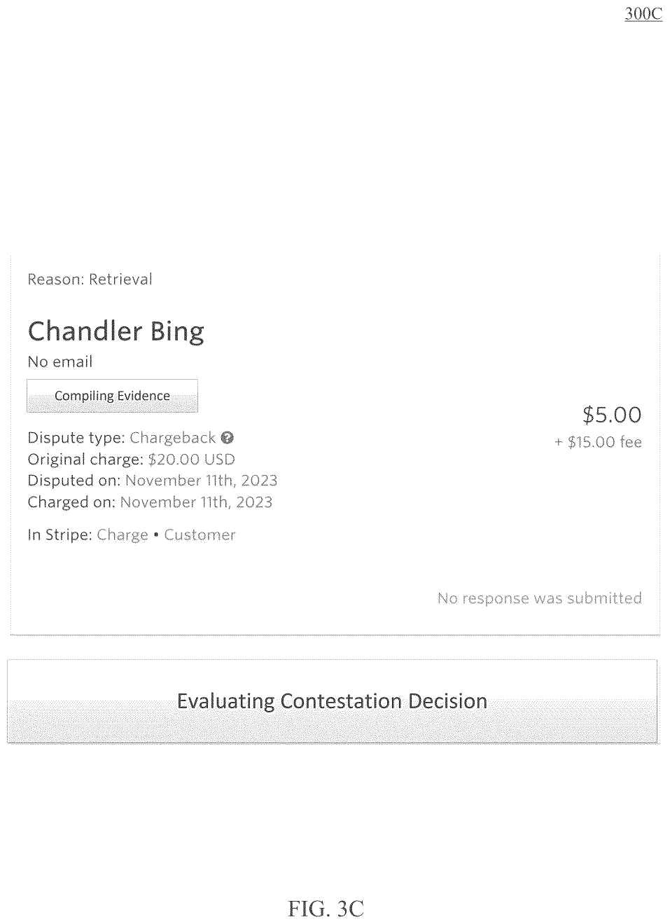

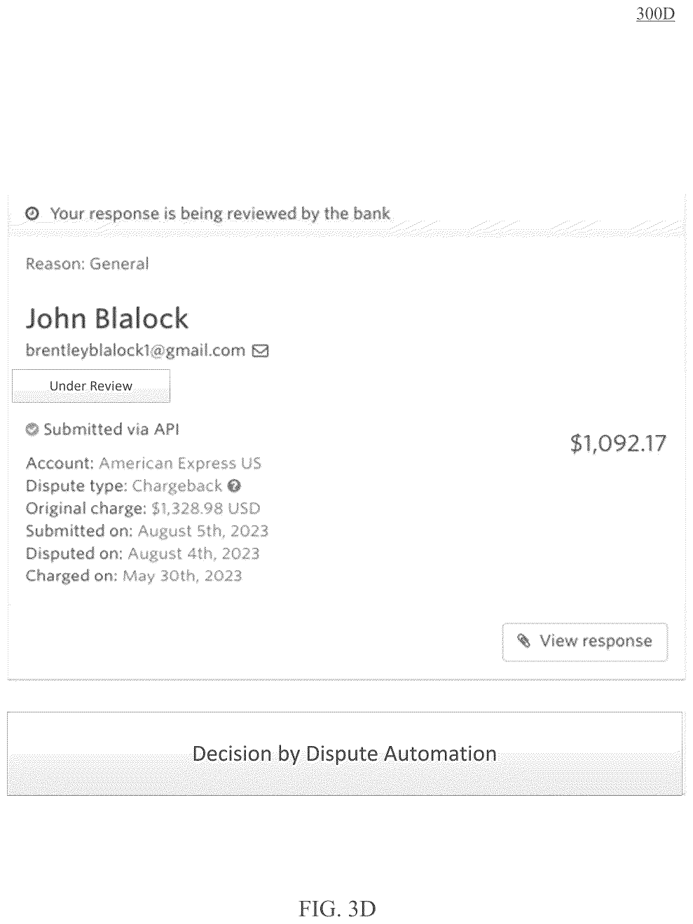

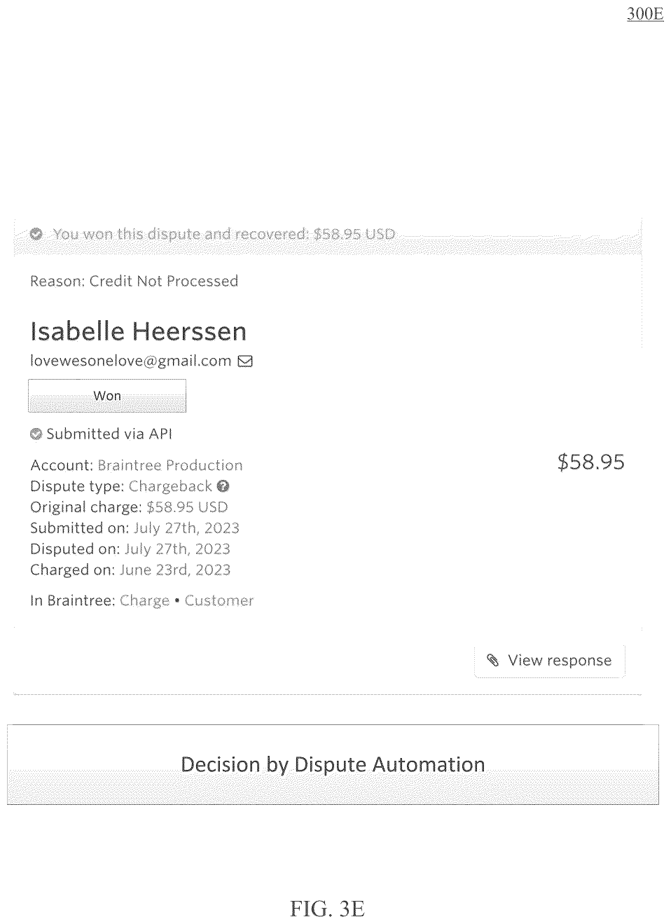

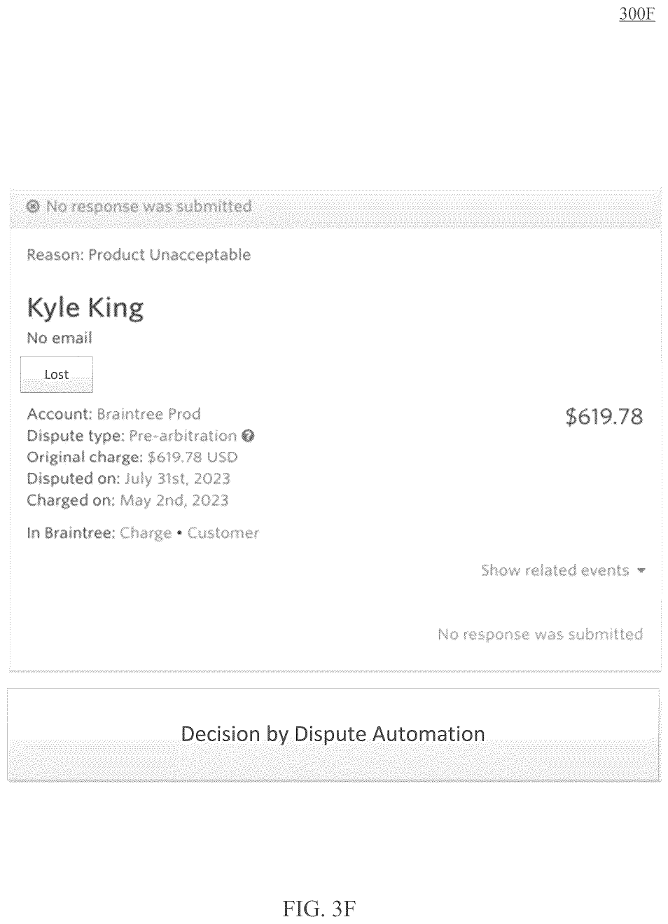

FIG. 2 is a block diagram 200 of a dispute processing system 120, according to some embodiments. Dispute processing system 120 may receive a chargeback request 202 from issuer system 116. Once received, dispute processing system 120 may transmit the chargeback request to dispute processing system interface 122, which may display chargeback request 202 and a transaction subject to the chargeback request. Dispute processing system interface 122 may also display the chargeback request 202 along with a listing of other chargeback requests associated with the service provider, as will be discussed in detail in FIG. 3A, below.

Dispute processing system 120 may include one or more service provider rules 204. Service provider rules 204 may be specific to a service provider and configured using dispute processing system interface 122. Service provider rules 204 may determine whether to accept the dispute associated with the chargeback request based on the transaction data included in chargeback request, such as disputed amount, date, user, or other information that may be configured by the service provider. Dispute processing system 120 may compare service provider rules 204 against transaction data and determine whether to accept the dispute or determine whether to contest the chargeback request. Service provider rules 204 may automatically contest the chargeback request for amounts above a predefined threshold or for users known to frequently contest transactions.

If service provider rules 204 determine to contest the chargeback request, dispute processing system 120 may begin to compile evidence. To compile evidence, dispute processing system 120 may include templates 206. Templates 206 may be populated with service provider or merchant data 208 and transaction data 210. Example service provider or merchant data 208 may include a product or service purchased, location of the service provider or merchant, service provider or merchant identifier, address and contact information, date of delivery, proof of delivery, reasons for the dispute, etc. Example transaction data may include a transaction identifier, location of the transaction, amount of the transaction, currency, name of the issuer, payment information, name of purchaser, purchaser contact information (e.g., an email, shipping and or billing address, and a telephone number), time of purchase, service provider information, etc. In some embodiments, templates 206 may be customized to a particular service provider using dispute processing system interface 122. For example, a service provider that provides a ride share service via one service provider server 106 may have different service provider or merchant data 208 than a service provider that sells services via a different service provider server 106 or a merchant that sells goods via merchant server 107.

In some instances, service provider or merchant data 208 and transaction data 210 may be stored in a data storage 212. Data storage 212 may be a database or another storage conducive for storing and retrieving large amounts of data. Although shown as a single storage, data storage 212 may comprise of multiple memory storages, such as those discussed in FIG. 7. Data storage 212 may be under control of service provider server 106 or payment provider server 108. Dispute processing system 120 may receive service provider or merchant data 208 and transaction data 210 from data storage 212 upon request.

In some embodiments, a service provider or merchant may also provide service provider or merchant data 208 using dispute processing system interface 122. For example, service provider or merchant data 208 may be uploaded to dispute processing system 120 via dispute processing system interface 122.

When service provider rules 204 determine to contest the chargeback request, dispute processing system 120 generates a contestation document 226, as will be discussed below. However, service provider rules 204 may also determine to evaluate the likelihood of succeeding in contesting the chargeback request. In this case, dispute processing system 120 automatically evaluates the likelihood of success before determining whether or not to contest the chargeback request.

In some embodiments, dispute processing system 120 may also include a machine learning framework 214. Machine learning framework 214 may be implemented in software, hardware, or a combination of both. Machine learning framework 214 may include one or more machine learning models 216, such as machine learning models 216A-D. Machine learning models 216A-216B may include neural networks or a combination of neural networks, such as a convolutional neural network, feed forward neural network, radial basis functional neural network, recurrent neural network, long short-term memory (LSTM) neural network, sequence neural network, modular neural network, and the like. Machine learning models 216C and 216D may be a decision tree model, that may be a random forest tree model, gradient boosting tree model, extreme gradient boosting tree model, or the like.

Machine learning models 216A-D may be trained on historical transaction data, historical service provider data, historical issuer data, or a combination of thereof. The historical transaction data may be used to create a buyer profile and identify device data associated with the historical transaction data. Additionally, the historical transaction data and historical service provider data may cause machine learning models 216A-D to use both buyer side and seller side data to determine machine learning scores 218. Once trained, machine learning models 216A-D may receive service provider or merchant data 208 and transaction data 210 associated with the chargeback request and determine one or more machine learning scores 218. In some embodiments, machine learning scores 218A-D may be generated from machine learning models 216A-216B and/or machine learning models 216C-216D, or a combination thereof. Machine learning scores 218A and 218C may identify a win rate for disputing a chargeback request without entering a pre-arbitration process, while machine learning scores 218B and 218D may identify a win rate for disputing a chargeback request during a pre-arbitration process. Machine learning scores 218A and 218C, and 218B and 218D may be generated to indicate chances of contesting and winning a chargeback request during different stages of the chargeback process. This is because, the likelihood of winning the chargeback request without entering the pre-arbitration process may be higher than the likelihood of winning the chargeback request during the pre-arbitration process. Also, a combination of machine learning scores, such as machine learning scores 218A-B and/or 218C-D may provide a higher accuracy of successfully contesting the chargeback request.

Machine learning scores 218A-D may be stored in a data store, such as data storage 212. In this way, machine learning scores 218A-D may be used to subsequently train machine learning framework 214 or be included in analytics engine 222 to determine the likelihood of winning similar chargeback requests using dispute processing rules 224 discussed below.

In some embodiments, machine learning framework 214 may execute on demand, or at predefined time intervals, such as every twelve or twenty-four hours. For example, when dispute processing system 120 determines that a contestation response to a chargeback request is due in less than a predefined time period, dispute processing system 120 may trigger machine learning framework 214 to generate machine learning scores 218. Alternatively, dispute processing system 120 may trigger machine learning framework 214 to generate machine learning scores 218A-B and/or 218C-D at a predefined time. In yet another embodiment, dispute processing system 120 may trigger machine learning framework 214 to generate machine learning scores 218A-B and/or 218C-D in real-time.

In some embodiments, dispute processing system 120 may generate computational variables 220. Computational variables 220 may be a subset of historical transaction data and service provider data that may be used to verify the accuracy of machine learning models 216A-D during training. Computational variables 220 may also be included in dispute processing rules 224 that determine whether to contest the chargeback request as discussed below.

Dispute processing system 120 may include an analytics engine 222. Analytics engine 222 may use dispute processing rules 224 to analyze service provider or merchant data 208, transaction data 210, machine learning scores 218A-B and/or 218C-D and computational variables 220 to determine whether to dispute a chargeback request. Example dispute processing rules 224 may include variables or a combinations of variables from one or more of computational variables 220, service provider or merchant data 208, and transaction data 210. The variables may be associated with the transaction location (e.g., country), amount of disputes associated with the user in the past, the card issuer, transaction amount, user device information, item in the transaction, user profile, transaction IP address, issuing bank, network processor, a business vertical, etc. Dispute processing rules 224 may then correlate one or more variables or combinations of variables and the values of the one or more machine learning scores 218A-D to determine a likelihood of succeeding in contesting the chargeback request. Dispute processing system 120 may also combine a number of rules from the dispute processing rules 224 in a sequential order to determine a likelihood of succeeding in contesting the chargeback request.

In some embodiments, dispute processing rules 224 may also be configured using dispute processing system interface 122. For example, dispute processing system interface 122 may receive and associate values with computing variables 220 included in dispute processing rules 214.

In some embodiments, analytics engine 222 may activate and determine a likelihood of succeeding in contesting a chargeback request as soon as the machine learning scores 218A-B and/or 218C-D and computational variables 220 are generated. An on-demand analysis may occur for time sensitive chargeback requests. In other embodiments, dispute processing system 120 may accumulate multiple chargeback requests over a predefined time interval and activate analytics engine 222 at predefined time intervals, such as every twelve or twenty-four hours.

If analytic engines 222 determines to dispute the chargeback request, dispute processing system 120 may automatically generate a contestation document 226. Contestation document 226 may be generated from service provider or merchant data 208 and transaction data 210 collected in templates 206. In some instances, contestation document 226 may be a portable format document. In other instances contestation document 226 may be formatted in a format compatible with issuer system 116. Once dispute processing system 120 generates contestation document 226, dispute processing system 120 may transmit contestation document 226 to issuer system 116. Dispute processing system 120 may also transmit a message 228 to dispute processing system interface 122 indicating that the chargeback request is under review by issuer system 116. In some instances, message 228 may also include contestation document 226 that was transmitted to issuer system 116. Subsequently, dispute processing system 120 may receive a message indicating whether the contestation chargeback request was won or lost, and generate a message 230 updating dispute processing system interface 122 with the status of the chargeback request.

If analytic engines 222 determines not to dispute the chargeback request, dispute processing system 120 may generate message 232 indicating that the chargeback request would not be contested due to a low likelihood of success. Dispute processing system interface 122 may display message 232 and the transaction subject to the chargeback request on the user interface.

In yet another embodiment, analytics engine 222 may provide a recommendation to a merchant or a service provider. The recommendation may be based on a score or statistical analysis determined by analytics engine 222 and indicate the likelihood that the merchant or the service provider have in disputing the service request. In this case, message 232 may include a recommendation that may be displayed at dispute processing system interface 122.

As dispute processing system 120 determines whether to dispute a chargeback request, dispute processing system 120 transmits messages with the status of the chargeback request, such as messages 228-232. In response, dispute processing system interface 122 may display the status of the chargeback request along with the details of the transaction subject to the chargeback request. As discussed above, dispute processing system interface 122 may be accessible to service provider server 106 and merchant server 107. FIGS. 3A-3E are diagrams 300A-E of a dispute processing system interface 122, according to some embodiments. FIG. 3A is a diagram 300A illustrating a total number of chargeback requests over a predefined time period, a number of chargeback requests that were disputed, a number of chargeback requests that were won, and a monetary amount that was recovered. In FIG. 3A, dispute processing system interface 122 illustrates three disputes for which dispute processing system 120 is compiling evidence, that is collecting transaction data 210 or service provider data 208.

FIG. 3B is a diagram 300B illustrating a chargeback request that was initiated and for which dispute processing system 120 is waiting for transaction data 210 or service provider or merchant data 208. Dispute processing system interface 122 may also receive input that includes transaction data 210 and/or service provider or merchant data 208. FIG. 3C is a diagram 300C illustrating a chargeback request for which dispute processing system 120 received transaction data 210 and service provider or merchant data 208 and is in a process of determining whether to dispute the chargeback request based on machine learning scores 218A-B and/or 218C-D generated by machine learning framework 214, and computational variables 220. Once dispute processing system 120 determines whether to contest the chargeback request, dispute processing system 120 may generate contestation document 226 using templates 206. Although not shown, dispute processing system interface 122 may also display a recommendation for submitting or not submitting contestation document 226. In this case, a recommendation may be displayed on an interface similar to an interface depicted in FIG. 3C. The dispute processing system 120 may then generate contestation document 226 after dispute processing system 120 receives a message with an indication to dispute the chargeback request. FIG. 3D is a diagram 300D illustrating a chargeback request for which dispute processing system 120 determined to proceed with the chargeback dispute and submitted contestation document 226 to issuer system 116. FIG. 3E is a diagram 300E illustrating a chargeback request for which dispute processing system 120 submitted contestation document 226 to issuer system 116 and received a message from the issuer system 116 that the service provider won the chargeback dispute. FIG. 3F is a diagram 300F illustrating a chargeback request for which dispute processing system 120 determined that the chargeback request should not be disputed because the dispute would likely be lost. Accordingly, dispute processing system 120 did not submit a dispute to issuer system 116.

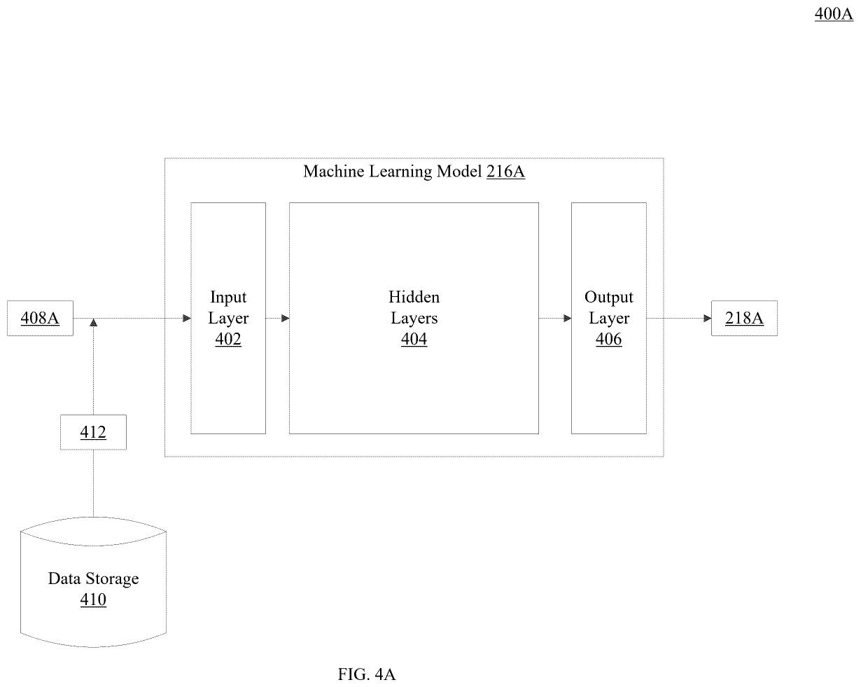

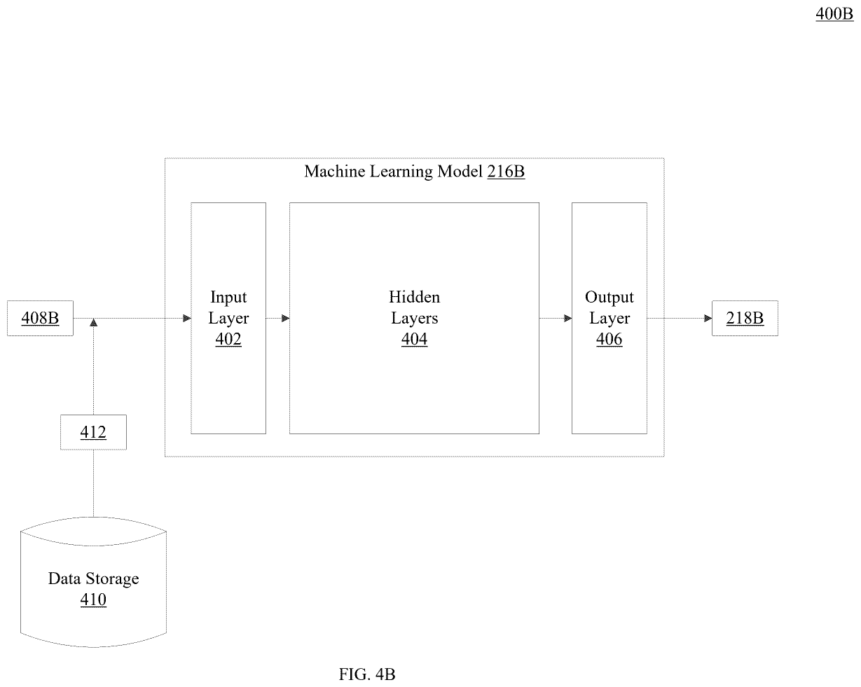

FIGS. 4A-B are block diagrams 400A-B of a machine learning models 216A-B, according to some embodiments. Machine learning models 216A-B may be a fully connected neural network that includes an input layer 402, multiple hidden layers 404, and output layer 406. A fully connected neural network may include multiple neurons at each one of layers 402-406, such that a neuron in one layer connects to all or a subset of neurons in the next layer. Each neuron may be associated with a non-linear activation function and a weighted matrix. The weighted matrix may apply a linear transformation to an input vector that the neuron receives. The non-linear transformation is applied to the product of the input vector and the matrix to generate an output. The output may be propagated to the next layer. In some embodiments, hidden layers 404 may include two layers, with thirty to fifty neurons in each layer.

Input layer 402 may receive an input vector 408A or 408B that includes service provider or merchant data 208 and transaction data 210. Transaction data 210 may be numeric or alphanumeric data. Each neuron in the input layer applies a linear transformation to the input vectors 408A or 408B using a weighted matrix, and a non-linear activation function to the product of the input vector and the weighted matrix to generate an output vector. The output vector is then an input vector to the neurons of the first hidden layer in hidden layers 404. Each neuron in the hidden layer then applies a linear transformation using its own weighted matrix to the input vector, and a non-linear activation function to the product of the input vector and the weighted matrix to generate an output vector. The process repeats until output layer 406 receives an input vector from the last hidden layer, applies a transformation matrix and generates an output. The output of output layer 406 may be machine learning score 218A for machine learning model 216A and machine learning score 216B for machine learning model 216B. Machine learning score 218A may be a number within a predefined range, such as a number between zero and one thousand, where one thousand indicates a high probability of winning a chargeback request without the pre-arbitration process and zero indicates a low probability of winning a chargeback request. Machine learning score 218B may be a number within a predefined range without a pre-arbitration process, such as a number between zero and one thousand, where one thousand indicates a high probability of winning a pre-arbitration process and zero indicates a low probability of winning a pre-arbitration process.

In some embodiments, data in input vectors 408A and 408B may be filtered. The filtered data may be a subset of the transaction data that is filtered using one or more filtering algorithms. For example, the filtered data may include a subset of service provider 208 and transaction data 210 with parameters relating to the transaction amount, transaction data, user identifier, device data, buyer information, item or service name, and IP address. Additionally, data may be filtered according to date parameters. For example, data within a predefined time period, e.g., past 90 days from today, may be excluded, while data after the predefined time period may aggregated over one or more predefined time periods, such as seven, thirty, ninety, and 180 days. The filtered data may include different parameters for input vectors 408A and 408B. After filtering, the size of the input vectors 408A and 408B may be one third to one tenth of the size of the transaction data 210. Further the input vectors 408A and 408B that includes filtered data may include data that is more relevant to determining machine learning scores 218A and 218B than data that is not included in input vectors 408A-B.

In some embodiments, data in input vector 408A and 408B may be supplemented with historical data 412. The historical data 412 may be user data, user profile data (e.g., how often a user disputes transactions, which methods of payment the user uses when the transactions are disputed, the fee amount for disputed transactions, and the like), service provider data, etc., and may include disputed and non-disputed transactions. Example data may include a transaction amount, transaction date, user identifier, user information (e.g., user email, telephone number, shipping address, billing address, and the like), device data from which a transaction has occurred (e.g., Internet Protocol (IP) address, device identifier, including IMEI (international mobile equipment identity) or MEID (mobile equipment identification), another device fingerprint), description of an item or service included in the transaction, and a dispute date (if any). In some instances, historical data 412 may be filtered to a predefined number of transactions, such as transactions with variables that are closest to the transaction subject to the chargeback request. Historical data 412 that supplements input vector 408A and 40B may be different for input vector 408A and 408B.

Historical data 412 may be collected over a predefined time period. For example, suppose the predefined time period is set to thirty days, one hundred and twenty days, or one year. Historical data 412 within the predefined time period may be collected and stored in data storage 410, which maybe the same or different storage as data storage 212 of FIG. 2. Historical data 412 may also be updated in real time. As days pass, e.g., the thirty day time period shifts, the new data may be stored as historical data 412 in real-time, once an hour, once a day, etc., and the obsolete data may be deleted from historical data 412.

With reference to FIG. 4A, during the training phase, machine learning model 216A may receive input vector 408A which may include historical data 412 that is associated with a transaction, service or merchant provider, or a combination thereof, in a training dataset. The training dataset also includes chargeback scores for transactions that indicate whether the chargeback requests will or will not be successful without entering the pre-arbitration process. Input vector 408A may be passed through machine learning model 216A to generate machine learning score 218A. Machine learning model 216A may compare the chargeback score associated with the transaction in the training dataset to machine learning score 218A it generates and determine the error. Based on the error, machine learning model 216A may modify the weights of the weighted matrixes and/or non-linear activation functions at one or more nodes according to a learning rate parameter. The training phase may continue for some or all transactions in the training dataset over a predefined number of iterations or until scores 218A generated by machine learning model 216A match the chargeback scores associated with the transactions in the training dataset with an error that is less than a predefined error.

Additionally, during the training phase the data in the input vector 408A may vary to determine a subset of variables in the contestation document 226 and/or historical data 412 that are indicative of correct chargeback scores 218A more than others. These variables may be computation variables 220 which may then be included in the dispute processing rules 224 to determine the likelihood of winning the chargeback request.

During the inference stage, machine learning framework 114A may receive input vector 408A. As discussed above, input vector 408A may be supplemented using historical data 412 collected over a predefined time interval. The historical data 412 may also be limited to a predefined number of transactions, such as top five or ten historical transactions that may resemble the transaction subject to a chargeback request. The input vector 408A may be filtered to include variables that machine learning model 216A identified as indicative of the correct chargeback scores, and passed through machine learning model 216A to generate machine learning score 218A.

With reference to FIG. 4B, during the training phase, machine learning model 216B may receive input vector 408B which may include historical data 412 that is associated with a transaction in a training dataset. The training dataset also includes pre-arbitration scores for transactions that indicate whether the pre-arbitration process will or will not be successful. Input vector 408B may be passed through machine learning model 216B to generate machine learning score 218B. Machine learning model 216B may compare the pre-arbitration score associated with the transaction in the training dataset to machine learning score 218B and determine the error. Based on the error, machine learning model 216B may modify the weights of the weighted matrixes and/or non-linear activation functions at one or more nodes according to a learning rate parameter. The training phase may continue for some or all transactions in the training dataset over a predefined number of iterations or until scores 218B generated by machine learning model 216B match the chargeback scores associated with the transactions in the training dataset with an error that is less than a predefined error.

Additionally, during the training phase the data in the input vector 408B may vary to determine a subset of variables in the contestation document 226 and/or historical data 412 that are indicative of correct pre-arbitration scores 218B more than others. These variables may be computation variables 220 (which may have parameters different from computation variables 220 used by machine learning model 216A) which may then be included in the dispute processing rules 224 to determine the likelihood of winning the pre-arbitration process.

During the inference stage, machine learning model 216B may receive input vector 408B. As discussed above, input vector 408B may be supplemented using historical data 412 collected over a predefined time interval. The historical data 412 may also be limited to a predefined number of transactions (which may also be different from historical data 412 used by machine learning model 216A), such as top five or ten historical transactions that may resemble the transaction subject to a chargeback request. The input vector 408B may be filtered to include variables that machine learning model 216B identified as indicative of the correct pre-arbitration process decision, and passed through machine learning model 216B to generate machine learning score 218B.

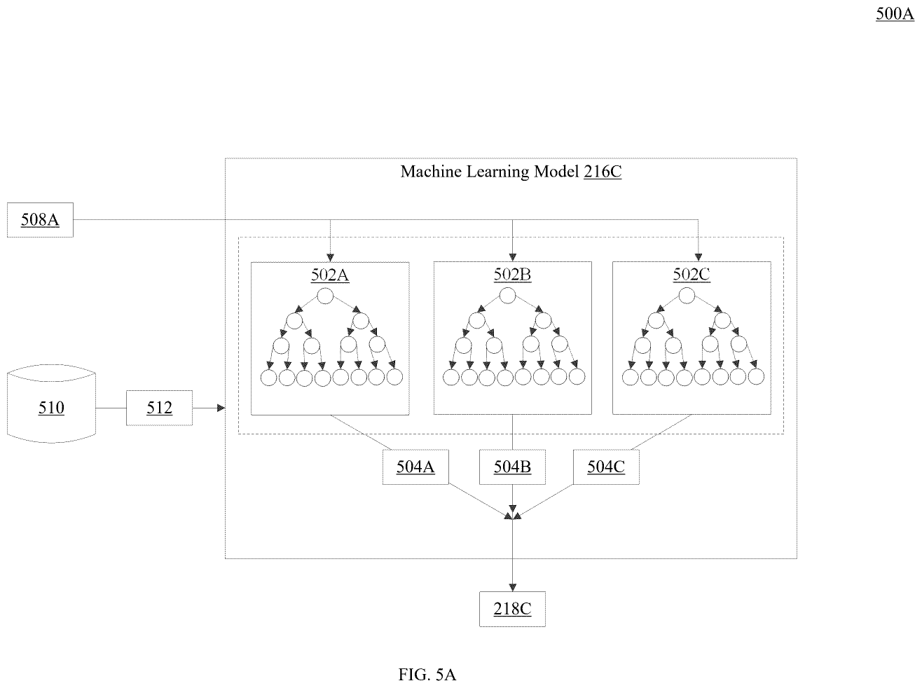

FIGS. 5A-B are block diagrams 500A-B of a machine learning models 216C-216D, according to some embodiments. Machine learning models 216C-216D may be a gradient boosting tree models that includes multiple decision trees referred to as ensemble of trees 502. Ensemble of trees 502 may receive input vectors 508A or 508B. Input vectors 508A and 508B may be input vectors 408A-B discussed above, or another vector that includes all or a subset of transaction data 210 and/or service provider or merchant data 208. Further variables in input vector 508A may be different from the variables in input vector 508B. FIGS. 5A-B illustrates ensemble of trees 502 that includes trees 502A-C in a non-limiting embodiment. The number of trees and the depth of each tree may be configured within machine learning models 216C and 216D. The nodes of each tree 502 may include one or more variables and corresponding variable values. The variables and variable values at each node may determine the path that input vectors 508A and 508B travel from the root node of the tree, down to the leaf nodes. For example, at each node, machine learning models 216C and 216D may compare the values of the variables associated with the node to the value of the variables in input vector 508A-B, and determine the path from the node based on the comparison. The leaf nodes may indicate a score 504, such as scores 504A-C for trees 502A-C that may indicate the chances of winning the chargeback request.

In some embodiments, machine learning models 216C and 216D may combine the scores 504A-C, combine and average scores 504A-C, and the like, to determine machine learning scores 218C-D. Machine learning models 216C-D may also assign different weights to each of the scores 504A-C when determining machine learning score 218C-D. Machine learning model 216C may determine machine learning score 218C. Machine learning score 218C may be a number within a predefined range, such as a number between zero and one thousand, where one thousand indicates a high probability of winning a chargeback request without entering a pre-arbitration process and zero indicates a low probability of winning a chargeback request without entering a pre-arbitration process. Machine learning model 216D may determine machine learning score 218D. Machine learning score 218D may be a number within a predefined range, such as a number between zero and one thousand, where one thousand indicates a high probability of winning a pre-arbitration process and zero indicates a low probability of winning a pre-arbitration process.

During the training stage, machine learning models 216C and 216D may build ensemble of trees 502. To build ensemble of trees 502, machine learning model 216B may use a training dataset that includes historical transactions 512, data identifying whether the transaction was contested or not contested, and whether a chargeback request was won for the contested transaction. Machine learning models 216C and 216D may then use gradient boosting to iteratively determine which variables and values of the variables may be included at each node of trees 502A-C to direct the path of the historical transactions 512 to leaf nodes that determine within a predefined error whether the chargeback request would be won or lost for a transaction. In some embodiments, the same or different variables may be associated with the nodes of different trees 502A-C and have the same or different values for determining the path through the trees 502A-C. The purpose of gradient boosting is to build trees 502A-C, where each subsequent tree in ensemble of trees 502 minimizes an error in ensemble of trees 502 between the actual results and an expected result. For example, tree 502B may be built to minimize an error generated by tree 502A, and tree 502C may be built to minimize an error generated by tress 502A and 502B.

In some embodiments, the training dataset, including historical transactions 512, may be stored in data storage 510, which may be the same or different storage as data storage 212 of FIG. 2. The training dataset may include historical transaction data, historical user data, and historical service provider or merchant data, etc., that is collected over a predefined time period. The greater the time period the more accurate the historical data may be.

Machine learning models 216C and 216D may be trained on the entire training dataset that includes contested data and non-contested data. Machine learning models 216C may also be trained on contested data only that includes labels that identify whether a chargeback request was won or lost. Machine learning models 216D may also be trained on contested data only that includes labels that identify whether a pre-arbitration process was won or lost. Notably, different data from the training dataset may be used to train machine learning model 216C and machine learning model 216D, as each of those models is trained for a different purpose, such as determining machine learning score 218C indicating the likelihood of winning the chargeback request and machine learning score 218D indicating the likelihood of winning the pre-arbitration process.

Additionally, during the training phase the data in the input vectors 508A and 508B may vary to determine a subset of variables in the contestation document 226 and/or historical transactions 512 that are indicative of correct machine learning scores 218C and 218D more than others. These variables may be computational variables 220 which may then be included in the dispute processing rules 224 to determine the likelihood of winning the respective chargeback request and pre-arbitration process.

With reference to FIG. 5A, during the inference stage, machine learning model 216C may receive input vector 508A. The input vector 508A may be filtered to include variables that machine learning model 216C uses to determine a path through trees 502A-C in ensemble of trees 502. Machine learning model 216C may propagate input vector 508A through ensemble of trees 502-A-C to determine machine learning score 218C representing the likelihood of wining the chargeback request.

With reference to FIG. 5B, during the inference stage, machine learning model 216D may receive input vector 508B. The input vector 508B may be filtered to include variables that machine learning model 216D uses to determine a path through trees 502A-C in ensemble of trees 502. Machine learning model 216D may propagate input vector 508B through ensemble of trees 502-A-C to determine machine learning score 218D representing the likelihood of wining the pre-arbitration process.

Going back to FIG. 2, analytics engine 222 may use dispute processing rules 224 to analyze service provider or merchant data 208, transaction data 210, machine learning scores 218A-B and/or 218C-D and computational variables 220 to determine whether to dispute a chargeback request. For example, suppose computational variables 220 include variables 220A, 220B, and 220C. The dispute processing rules 224 may be:
If variable 220A>40 and machine learning score 218C<300, then accept and not contest the chargeback request.
If variable 220B<100 and variable 220C>50 and machine learning score 218D>500, then contest the chargeback request.
If variable 220C>100 and machine learning score 218C>50 and machine learning score 218D<75, then accept and not contest the chargeback request.

Notably, dispute processing rules 224 may combine different values for service provider or merchant data 208, transaction data 210, computational variables 220. Also, dispute processing rules 224 may combine differ machine learning scores 218A-D from the same or different machine learning models 216A-D, such that the rules may include machine learning scores 218C and/or 218D in one embodiment, and machine learning scores 218A and 218D in another embodiment. Dispute processing rules 224 may also be configurable and change as machine learning models 216A-D are retrained, and as computational variables 220 change to maximize recovery due to chargeback requests for merchants and service providers.

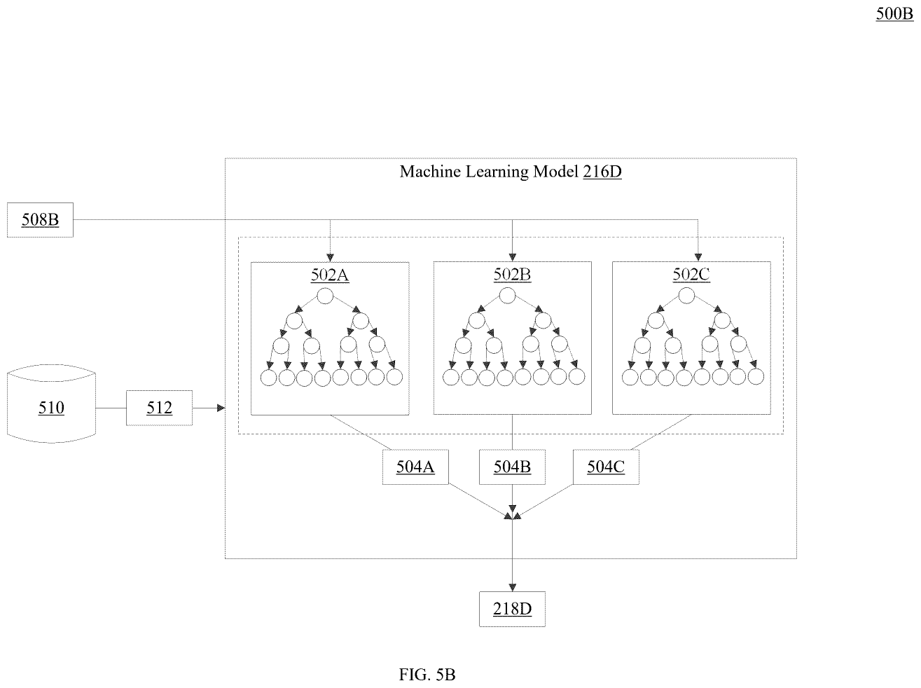

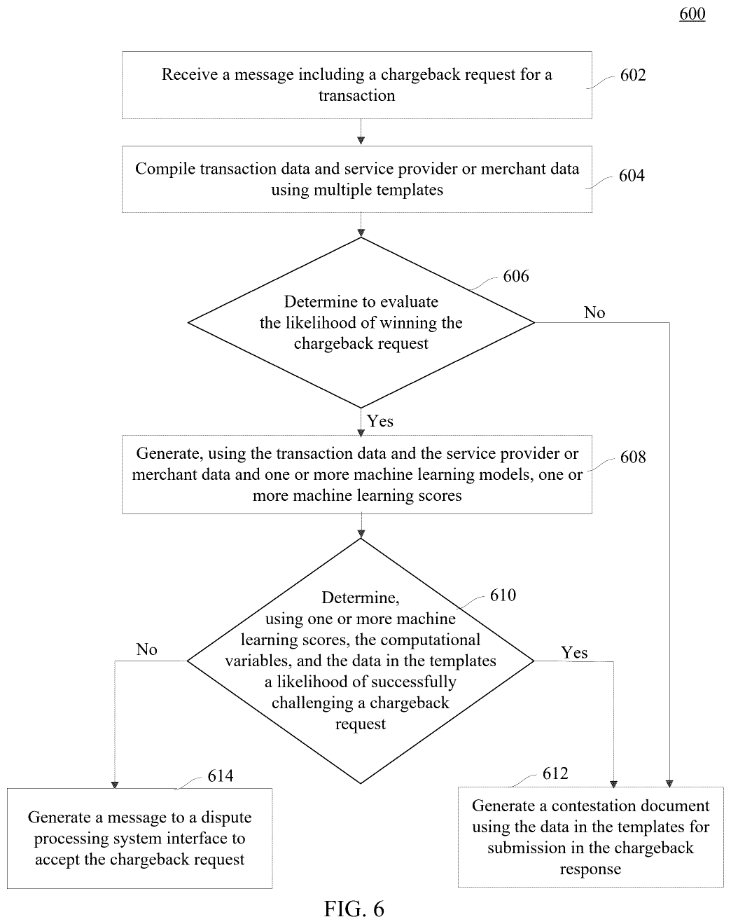

FIG. 6 is a flowchart of a method 600 for automatically determining whether to contest a chargeback request, according to an embodiment. Method 600 may be performed using hardware and/or software components described in FIGS. 1-5. Note that one or more of the operations may be deleted, combined, or performed in a different order as appropriate.

At operation 602, a chargeback request is received. For example, dispute processing system 120 receives a chargeback request from issuer system 116. Dispute processing system 120 may cause dispute processing system 120 to display the transaction subject to the chargeback request as shown in FIG. 3B.

At operation 604, evidence is compiled. For example, dispute processing system 120 may receive transaction data 210 and service provider or merchant data 208, and use the transaction data and service provider data to generate contestation document 226 using one or more templates 206.

At operation 606, a determination to evaluate the likelihood of winning the chargeback request is made. For example, dispute processing system 120 may invoke configurable one or more service provider rules 204 that are specific to a service provider to determine whether to contest the chargeback request or to determine the likelihood of winning the chargeback request. If service provider rules 204 indicate to contest the chargeback request, method 600 proceeds to operation 612. On the other hand, if service provider rules 204 indicate that the likelihood of winning the chargeback request should be evaluated, method 600 proceeds to operation 608, and dispute processing system 120 may switch the status of the transaction subject to the dispute to compiling evidence as shown in FIG. 3C.

At operation 608, machine learning scores are generated. For example, machine learning framework 214 may use one or more machine learning models, such as machine learning models 216A-B and/or 216C-D to generate respective machine learning scores 218A-B and/or 218C-D. As discussed above, machine learning scores 218A and 218C may indicate a likelihood of winning a chargeback request, and machine learning scores 218B and 218D may indicate a likelihood of winning a pre-arbitration process. In some instances, machine learning framework 214 may execute at predefined time intervals, such as once a day or every 24 hours. In other instances, machine learning framework 214 may execute on demand. This may occur, for example, if the chargeback request indicates that a response is due within less than a predefined time period.

At operation 610, a likelihood of winning the chargeback request is determined. For example, dispute processing system 120 may apply the machine learning scores 218A-B and/or machine learning scores 218C-D, computational variables 220, the transaction data 210 and service provider or merchant data 208 in dispute processing rules 224 to determine the likelihood of succeeding in contesting the chargeback request. As discussed above, dispute processing rules 224 may be configurable, sequential, and evaluate multiple variables. If operation 610 indicates that the chargeback request is likely to be won, method 600 proceeds to operation 612. If operation 610 indicates that the chargeback request is not likely to succeed, method 600 proceeds to operation 614.

At operation 612, a contestation document is generated. For example, dispute processing system 120 may use transaction data 210 and service provider or merchant data 208 to generate contestation document 226. Dispute processing system 120 may then automatically format the contestation document 226 transmit the contestation document 226 to issuer system 116. If the contestation document 226 is transmitted to issuer system 116, dispute processing system 120 may switch the status of the transaction subject to the dispute to under review as shown in FIG. 3D.

At operation 614, a message not to dispute a chargeback request is generated. For example, dispute processing system 120 may switch the status of the transaction subject to the lost review as shown in FIG. 3F because the chargeback request was not submitted to issuer system 116.

Referring now to FIG. 7 an embodiment of a computer system 700 suitable for implementing, the systems and methods described in FIGS. 1-6 is illustrated.

In accordance with various embodiments of the disclosure, computer system 700, such as a computer and/or a server, includes a bus 702 or other communication mechanism for communicating information, which interconnects subsystems and components, such as a processing component 704 (e.g., processor, micro-controller, digital signal processor (DSP), graphics processing unit (GPU), etc.), a system memory component 706 (e.g., RAM), a static storage component 708 (e.g., ROM), a disk drive component 710 (e.g., magnetic or optical), a network interface component 712 (e.g., modem or Ethernet card), a display component 714 (e.g., CRT or LCD), an input component 718 (e.g., keyboard, keypad, or virtual keyboard), a cursor control component 720 (e.g., mouse, pointer, or trackball), a location determination component 722 (e.g., a Global Positioning System (GPS) device as illustrated, a cell tower triangulation device, and/or a variety of other location determination devices known in the art), and/or a camera component 723. In one implementation, the disk drive component 710 may comprise a database having one or more disk drive components.

In accordance with embodiments of the disclosure, the computer system 700 performs specific operations by the processor 704 executing one or more sequences of instructions contained in the memory component 706, such as described herein with respect to the mobile communications devices, mobile devices, and/or servers. Such instructions may be read into the system memory component 706 from another computer readable medium, such as the static storage component 708 or the disk drive component 710. In other embodiments, hard-wired circuitry may be used in place of or in combination with software instructions to implement the disclosure.

Logic may be encoded in a computer readable medium, which may refer to any medium that participates in providing instructions to the processor 704 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that comprise the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 700. In various other embodiments of the disclosure, a plurality of the computer systems 700 coupled by a communication link 724 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A method comprising:
receiving, at a dispute processing system executing on a processor, a chargeback request for a transaction;
receiving transaction data and service provider data associated with the transaction;
incorporating the transaction data and the service provider data into an at least one template;
generating, using at least one machine learning model in a machine learning framework executing on the processor, at least one machine learning score, wherein the at least one machine learning score indicates a likelihood of successfully winning the chargeback request;
determining, using the at least one machine learning score, the transaction data, the service provider data, and at least one dispute processing rule in a plurality of dispute processing rules, the likelihood of successfully winning the chargeback request;
based on the likelihood of winning the chargeback request, generating from the at least one template a contestation document; and
submitting the contestation document to contest the chargeback request.

2. The method of claim 1, further comprising:
determining, using the at least one machine learning score, the transaction data, the service provider data, and the at least one dispute processing rule a likelihood of successfully winning a pre-arbitration processes.

3. The method of claim 1, further comprising:
transmitting, to a dispute processing system interface, a message indicating a status of the chargeback request; and
displaying, on the dispute processing system interface, the status of the chargeback request and details of the chargeback request.

4. The method of claim 1, wherein the at least one machine learning model is a neural network model including an input layer, and output layer, and a plurality of hidden layers.

5. The method of claim 4, further comprising:
receiving, at the input layer, an input vector comprising the transaction data and the service provider data, to generate a plurality of input layer outputs;
applying, at each neuron in a hidden layer of the plurality of hidden layers, a weighted matrix and an activation function to each input layer output, to generate a hidden layer output; and
generating, at the output layer, the at least one machine learning score from the hidden layer output.

6. The method of claim 4, further comprising:
receiving, at the input layer, an input vector comprising a subset of transaction data and the service provider data; and
generating, by applying at least one weighted matrix and at least one activation function at the input layer, the plurality of hidden layers, and the output layer, the at least one machine learning score from the input vector.

7. The method of claim 4, further comprising:
generating an input vector from the transaction data, the service provider data, and historical data, the historical data comprising data collected over a predefined time period; and
generating, by applying at least one weighted matrix and at least one activation function at the input layer, the plurality of hidden layers, and the output layer, the at least one machine learning score from the input vector.

8. The method of claim 1, wherein the at least one machine learning model includes an ensemble of trees, and further comprising:
propagating an input vector through each tree in the ensemble of trees by comparing variables in the input vector to variables at nodes in the each tree until a leaf node of the each tree is reached;
determining a tree score for the each tree based on the leaf node of the each tree; and
combining tree scores of the ensemble of trees into the at least one machine learning score.

9. The method of claim 1, further comprising:
determining a predefined time interval for submitting the contestation document to contest the chargeback request; and
based on the determining, activating the machine learning framework to generate the at least one machine learning score on demand or at predefined time intervals.

10. A system comprising:
a non-transitory memory storing instructions; and
one or more hardware processors coupled to the non-transitory memory and configured to read the instructions from the non-transitory memory to cause the system to perform operations comprising:
receiving, at a dispute processing system executing on a processor, a chargeback request for a transaction;
generating, using at least one machine learning model in a machine learning framework and data associated with the transaction, a machine learning score, wherein the machine learning score indicates a likelihood of successfully winning the chargeback request;
determining, using a plurality of dispute processing rules, the machine learning score, a plurality of computational variables and the data associated with transaction the likelihood of successfully winning the chargeback request;
generating, using at least one template and the data associated with the transaction, a contestation document; and
submitting the contestation document to contest the chargeback request.

11. The system of claim 10, wherein the operations further comprise:
transmitting, to a dispute processing system interface, a message indicating the chargeback request for the transaction;
updating a display displaying a plurality of transactions associated with chargeback requests with the transaction.

12. The system of claim 10, wherein the operations further comprise:
transmitting, to a dispute processing system interface, a plurality of messages, each message indicating an updated status of the chargeback request; and
updating status of the chargeback request displayed on the dispute processing system interface upon receipt of the each message.

13. The system of claim 10, wherein the at least one machine learning model is a convolutional neural network model including a plurality of hidden layers with a weighted matrix and an activation function at each neuron in the plurality of hidden layers.

14. The system of claim 13, wherein the operations further comprise:
receiving at an input layer of the at least one machine learning model, an input vector comprising the data associated with the transaction and historical data collected over a predefined time interval;
applying, at each neuron in a hidden layer of the plurality of hidden layers, the weighted matrix and the activation function to each input layer output, to generate a hidden layer output; and
generating, at an output layer of the machine learning model, the machine learning score from the hidden layer output.

15. The system of claim 10, wherein the at least one machine learning model includes an ensemble of trees, and further comprising:
propagating an input vector through each tree in the ensemble of trees by comparing variables in the input vector to variables at nodes in each tree until a leaf node of each tree is reached;
determining a tree score for each tree based on the leaf node of each tree;
applying a weight to the tree score for each tree; and
combining weighted tree scores of the ensemble of trees into the machine learning score.

16. The system of claim 10, wherein the data associated with the transaction in the contestation document includes transaction data and service provider data.

17. A non-transitory machine-readable medium having stored thereon machine-readable instructions executable to cause a machine to perform operations comprising:
receiving, at a dispute processing system executing for a processor, a chargeback request for a transaction;
collecting data associated with the transaction;
generating, using a machine learning model and the data associated with the transaction, a machine learning score, wherein the machine learning score indicates the likelihood of successfully contesting the chargeback request;
determining, using a plurality of dispute processing rules, the machine learning score, a plurality of computational variables and the data associated with the transaction a likelihood of winning the chargeback request without a pre-arbitration process;
generating, using at least one template and the data associated with the transaction, a contestation document; and
submitting the contestation document to contest the chargeback request.

18. The non-transitory machine-readable medium of claim 17, further comprising:
determining that a time to respond to the chargeback request is less than a predefined time; and
activating the machine learning model to generate the machine learning score when the time to respond to the chargeback request is less than the predefined time.

19. The non-transitory machine-readable medium of claim 17, further comprising:
training the machine learning model using historical data associated with historical transactions, wherein historical transactions includes disputed transactions and not disputed transactions and is collected over a predefined time period.

20. The non-transitory machine-readable medium of claim 17, further comprising:
training the machine learning model to generate an ensemble of trees using historical data associated with the transactions, wherein nodes of each tree in the ensemble of trees includes at least one variable and a value associated with the at least one variable that determine a path through the each tree, wherein the path determines the machine learning score.
